(19) United States
(12) Patent Application Publication
(10) Pub. No.: US 2002/0184066 A1
(43) Pub. Date: Dec. 5, 2002

(54) Method and apparatus for combining customer actions based on prior actions

(75) Inventor: James T. Brady, San Jose, CA (US)

Correspondence Address: Paul D. Greeley, Esq., Ohlandt, Greeley, Ruggiero & Perle, L.L.P., One Landmark Square, 10th Floor, Stamford, CT, 06901-2682, US

(73) Assignee: FORECOURT COMMUNICATION GROUP

(21) Appl. No.: 10/154,502

(22) Filed: May 23, 2002

Related U.S. Application Data
(60) Provisional application No. 60/294,057, filed on May 29, 2001.

(51) Int. Cl. G06F 17/60

(52) U.S. Cl. 705/7

(57) ABSTRACT

Apparatus, and a corresponding method, present to a users various activities to the user, when the user is using a terminal in a manner that uses prior history of the actions of the user to prepare dialogs for the user that are more efficient. That is, take fewer actions or less time on the part of the user to complete the activities.

### FIELD OF THE INVENTION

This invention relates to the use of point-of-service termials by user in various venues, where said terminals are used to present various activities to the customer. The invention deals with a method and apparatus to improve the efficency of the customers use of said terminals.

### BACKGROUND OF THE INVENTION

This invention relates to a method of improving the efficency of a customer's interaction with a Point-of-service Termial based on the customer's prior usage of that or other terminal. Said terminal being use to present various activities to the customer.

This invention relates generally to Point-of-sale computer systems of the type used in multilane retail stores, gas stations and banks to record transactions. Specifically, the invention relates to point-of-service systems that can handle the presentation of visual or audio information to the customer in the form of various activities, and allow that customer to respond to that information. Point-of-sale systems have mechanisms for inputting a code recorded on a credit card, debit card, loyalty card, drivers license, and/or acquiring via some other means the identification of a customer being serviced. Such mechanisms include magnetic track readers (commonly called ‘stripe readers’), key pads, and touch screenss.

During the final minutes of a purchase of products in a retail environment, the customer is faced with a period of idle time. In a multilane store (grocery, variety goods . . . ) the customer waits for the checkout clerk to ring up the various purchases. In a gas station, the customer waits for the attendant or pump to fill the tank. This is wasted. Time. In general, neither the customer nor the store benefits from the activities of the customer during this time.

Two significant problems exist in this environment. They are the need to make best use of the limited amount of time the customer will have to use said terminal. In most environments said idle time is limited, and the tendency of people to lose interest if they are required to repeat the same actions a number of times. This invention will alow the activity presenting mechansim to construct new dialogs, based on experience in the venue of the point-of-service terminal or with the customer. Said new dialogs will require fewer steps on the part the customer to complete an activity. Thus the activities will be completed sooner. This address both of the problems mentioned above.

### SUMMARY OF THE INVENTION

The method of the invention involves the collecting of information about the actions of the customer in a specific venue, at a time of day, and date; building profiles regarding specific consumers and generic consumers; collecting information about a current retail transaction, and using that information in whole or in part to optimize the customer idle time. An optimization takes into effect the probablity of the customer performing specific sequences of actions, and then using that information to produce custom dialogs for that customer in order to minimize the number of actions needed to complete activities.

A number of means are provided to: identify the customer; identify the venue; log frames (screens or audio) presented to the customer; log the selection made by the customer; relate the selection to a specific ad, coupon, product offering, or service offering; to construct custom dialogs leading to specific ads, coupons, product offerings and service offerings.

The invention performs the steps of collecting information from customer transactions at specific store locations; aggregating that information at a computer; analyzing the aggregated information to: extract the probability of habitual activities, determining a likely speed of the customers response to various presentations, determining repeated sequences of actions that can be combined into a fewer number of actions; constructing dialogs requiring the fewer number of actions; assigning these dialogs to specific customers or venues, detecting the customers presence at the point-of-service terminal; determining whether to use a customer specific or venue dialog; and presenting the dialog to the customer.

### BRIEF DESCRIPTION OF THE DRAWINGS

FIG. 1 is an Overview diagram of the flow of information in the system implementing the invention.

FIG. 2 is a diagram of a computer System, which is adapted to perform the method of the invention.

FIG. 3 is a diagram of a computer system called the Central Server.

FIG. 4 is a diagram of a computer system called the Venue Server.

FIG. 5 is a diagram of a User Interface.

FIG. 6 is a diagram of a tree structure that represents a User Dialog

FIG. 7 is a data table that describes a Frame Instrumentation Messages.

FIG. 8 is a data table that describes a User Selection Instrumentation Messages.

FIG. 9 is a data table that describes an Instrumentation Table.

FIG. 10 is a data table that describes a User Profile Table.

FIG. 11 is a data table that describes a Venue Definition Table.

FIG. 12 is the Activity Table.

FIG. 13 Selection Table

FIG. 14 Activity Summary Table

FIG. 15 Frame Summary Table

FIG. 16 is a data table that describes a User Session Table.

FIG. 17 Dialog Index Table

FIG. 18 is a flow chart describing the Selection of Proposed Activities.

FIG. 19 Construct New Activity

### DETAILED DESCRIPTION OF THE INVENTION

The invention is described in terms of a multilane store (that is, a store with multiple checkout counters), but applies to other retail, wholesale, and financial institutions.

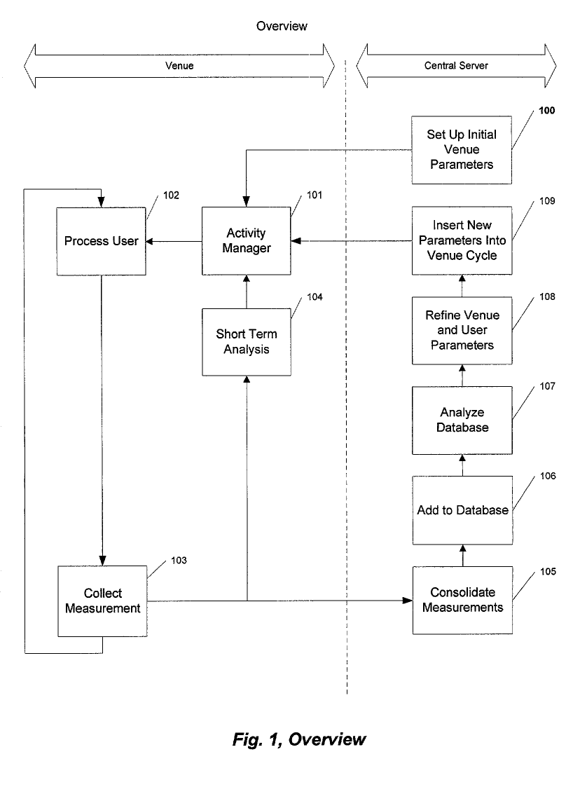

FIG. 1 describes the flow of information in the system. In a venue there is a established process for collecting payment from a user. This is represented in Process User 102. Prior to the installation of an implementation of this invention the process deals with ‘ringing up’ the prices of the items purchased, establishing the total price, and collecting that total from the user; then repeating the process with subsequent customers. This process is modified to present information to the user during the times in the Process User 102 that the user is idle (normally this is while the purchases are being ‘rung up’). To affect this, a cycle is set up where the Activity Manager 101 is repeatedly refined with time measurements it collects in Consolidate Measurements 105. These are analyzed and the new parameters are integrated into the system for the Activity Manager 101 to Process User 102 more effectively. Another, shorter cycle, processes the collected data in Short Term Analysis 104 with changes in system and user response time.

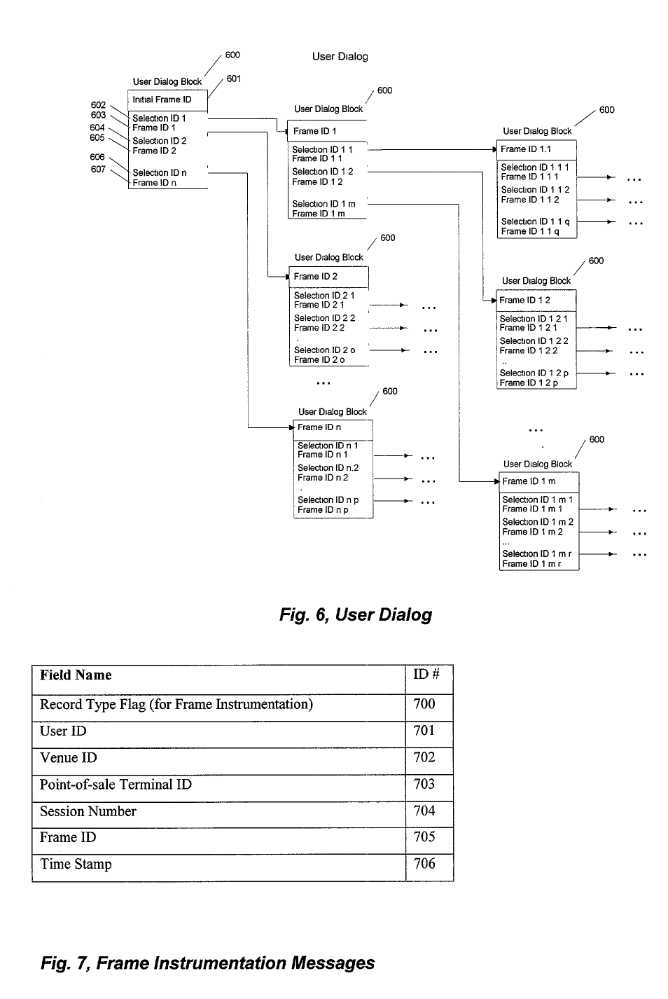

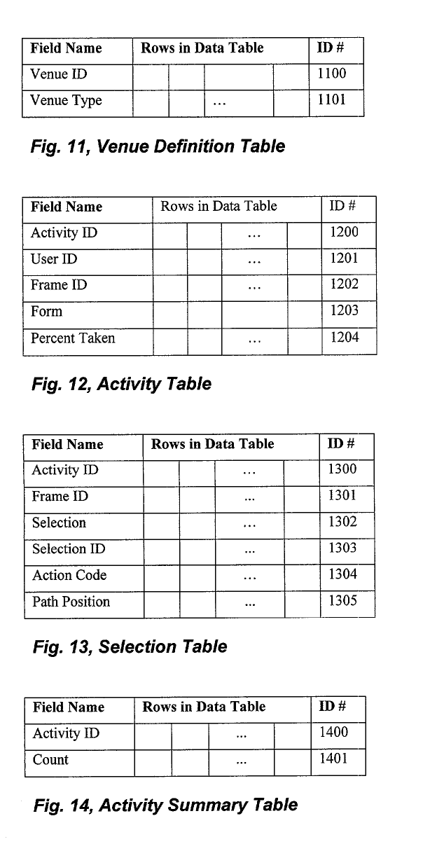

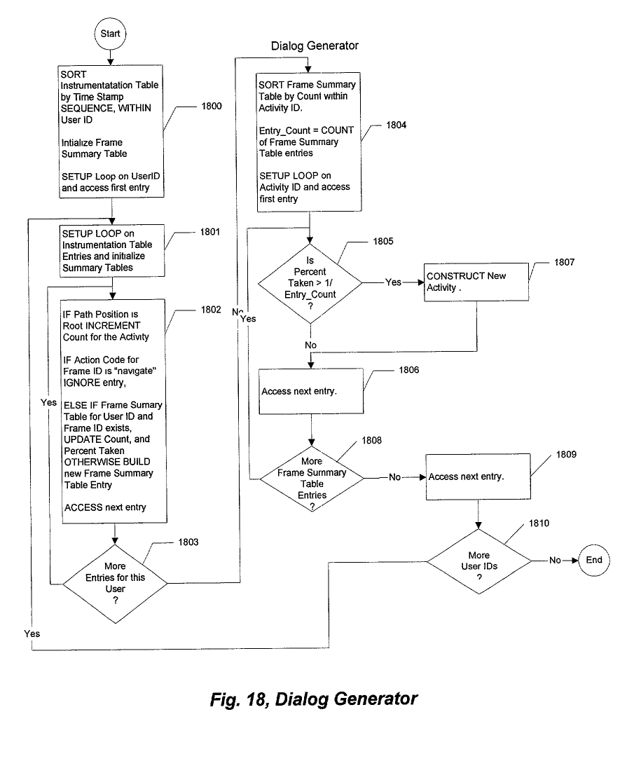

Once the venue has been set up, Set Up Initial Venue Parameters 100 communicates to the Activity Manager 101 a set of default parameters including FIG. 10, User Profile Table; FIG. 11, Venue Defintion Table; FIG. 11, User Dialog, FIG. 6, User Profile Table, and FIG. 12, Activity Table. Process User 102, prompts Activity Manager 101 with a User ID supplied by the User Interface 204. The Activity Manager 101, using the available data constructs selects an activity to present to the user, as described in FIG. 18, Selection of Proposed Activities, and transforms that activity into a FIG. 6, User Dialog.

Process User 102 uses the FIG. 6, User Dialog, to control the presentation of the activity to the user.

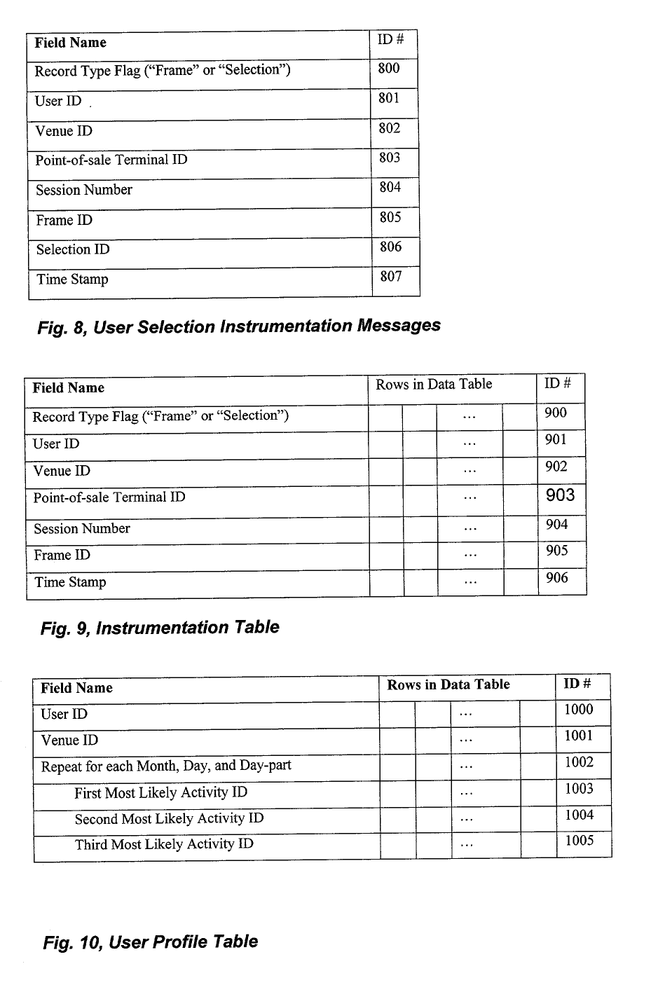

As activities are presented and responded to, FIG. 7, Frame Instrumentation Messages, and FIG. 8, User Selection Instrumentation Messages, are generated. These are transmitted to Collect Measurement 103 for transmission to Short Term Analysis 104 and Consolidate Measurements 105. Short Term Analysis 104 uses the information to update the venue copy of FIG. 10, User Profile Table. Consolidate Measurements 105, pools the information for a period of time (say a month) adding it to a database of measurements (Add to Database 106), then Analyze Database 107 is triggered to determine which profiles should be updated and then passes control to Refine Venue and User Parameters 108 which generates a new set of FIG. 6, User Dialogs. Insert New Parameters Into Venue Cycle 109 takes that information and inserts it into the appropriate venue's Activity Manager 101, completing the cycle.

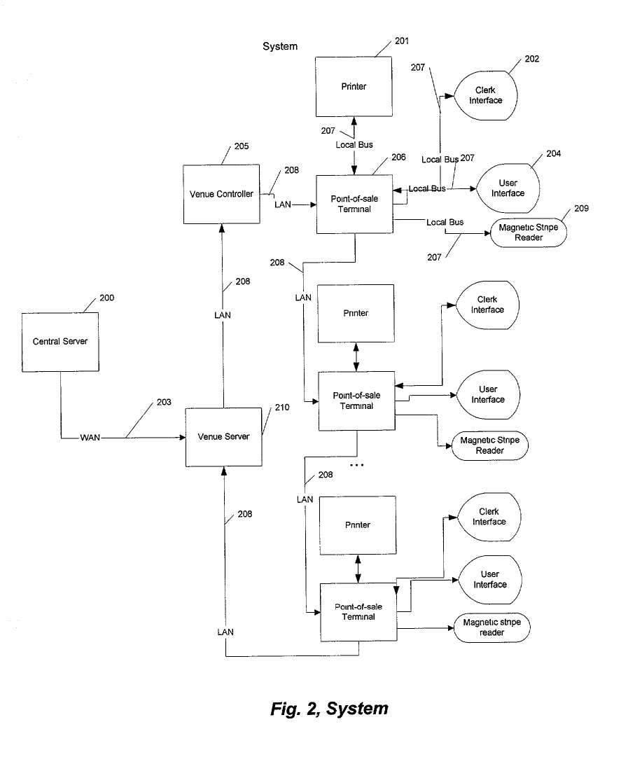

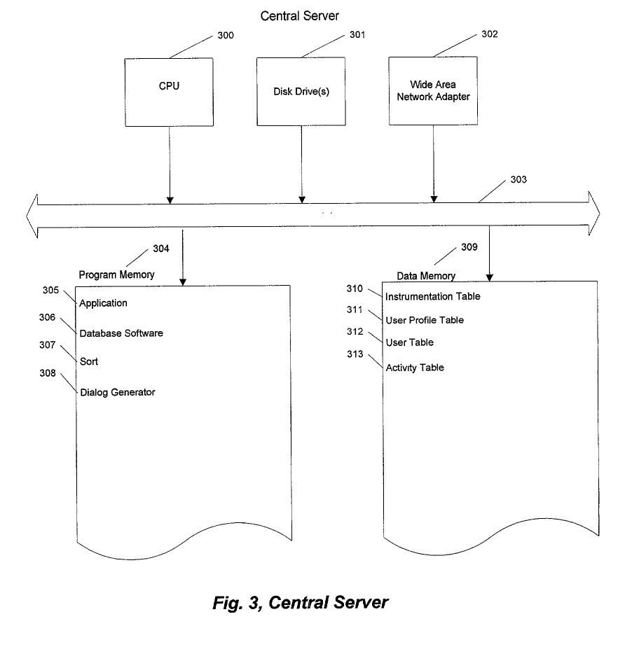

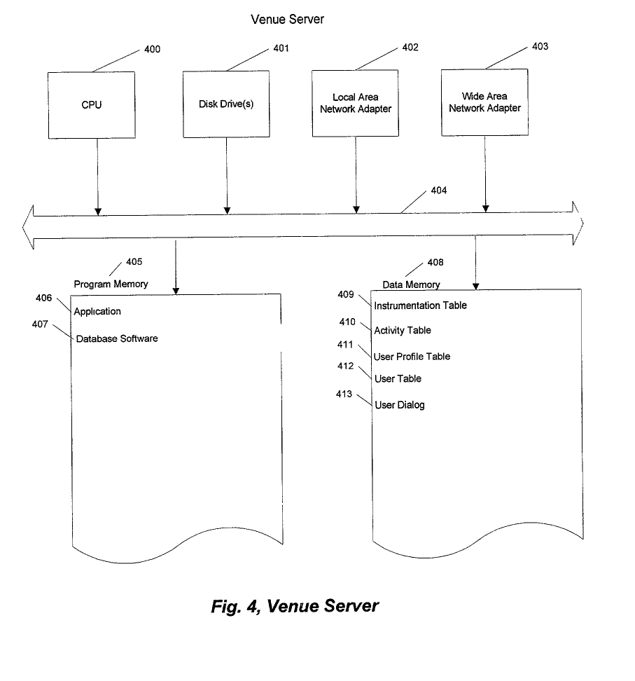

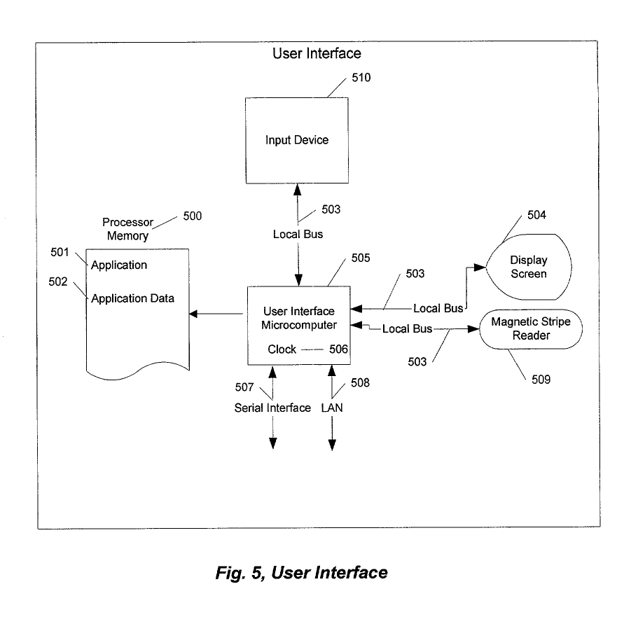

FIG. 2 is a diagram of a network of computers adapted to perform the method of the invention. A Central Server 200, described in FIG. 3, is coupled by a wide area network, WAN 203 to one or more Venue Server 210. Readily available software and protocols such as TCP/IP are used by Central Server 200 and Venue Server 210, described in FIG. 4, to communicate with each other via WAN 203. Venue Controller 205 and Venue Server 210 are connected via LAN 208 to one or more Point-of-sale Terminal 206. Normal Point-of-sale Terminal activities are conducted between the Venue Controller 205 and Point-of-sale Terminal 206. Connect to the Point-of-sale Terminal 206 via a Local Bus 207 are the User Interface 204, Clerk Interface 202, Magnetic Stripe Reader 209 and a Printer 201. User Interface 204, described in FIG. 5, has a Display Screen 504 and Input Device 510 for communicating with the User. Magnetic Stripe Reader 209 and/or Input Device 510 allow the input of user identification information from a variety of identification cards or manually, and are often the source of the first user response. These are described in greater detail in FIG. 5. The Clerk Interface 202 is normally involved with checkout processing. Output device, Printer 201, is for hardcopy printouts such as receipts, advertisements, coupons and other information.

FIG. 3 Illustrates further details of Central Server 200 as seen in FIG. 2, System. Central Server performs the functions of collecting user data and venue data, analyzing the data to extract information concerning buying habits and thinking characteristics of the user, and information about the performance characteristics of the venue. CPU 300 is a conventional microprocessor with a Local Bus 303 that connects it to Disk Drive(s) 301, a Wide Area Network Adapter 302, a Program Memory 304 and a Data Memory 309. Program Memory 304 contains Application 305 that performs the following functions. It collects information stored in Venue Server 210 via WAN 203 using standard communication protocols such as TCP/IP. The information collected is in the form of the following tables: Instrumentation Table 310, and Activity Table 313. This information is stored using Database Software 306 into Data Memory 309 and subsequently onto Disk Drive(s) 301. A generalized Sort 307 is used by Dialog Generator 308 to order data as described in FIG. 18, Dialog Generator.

Periodically a Dialog Generator 308 analyzes the data to produce a collection of FIG. 6, User Dialogs. These are sent to the Venue Servers 210 specified by the Venue ID 1700.

User Table 312, contains basic information about a customer and is used as linkage between the various forms of customer identification and the User Profile Table 311. Activity Table 313 provides the characteristics of the various User Dialogs, that are available to be selected to be sent to the various stores.

FIG. 4 Venue Server, is a representation of a Venue Server 210, from FIG. 2. Venue Server is described as though it is implemented as a separate computer system, however the function provided can be performed in Venue Controller 205 or other computer systems in the Venue. FIG. 4, Venue Server, is controled by CPU 400 and communicates with Central Server 200 via Wide Area Network Adapter 403 to acquire the information and store it in Data Memory 408 and on Disk Drive(s) 401. Internally the various components communicate via Local Bus 404 The tables acquired are: User Profile Table 411 (described in FIG. 6), User Table 412 (described in FIG. 13), and FIG. 6 User Dialog. Application 406 contains the program describe in FIG. 18, Selection of Proposed Activities, which describes how User Dialog 413 is constructed. Application 406, in Program Memory 405, makes use of commercially available Database Software 407 to the provide storage, selection and retrieval functions that it needs.

Data Memory 408 also Instrumentation Table 409 (described in FIG. 9), is composed of FIG. 8, User Response Instrumentation Messages; FIG. 7, Frame Instrumentation Messages; and Activity Table 410 that is described in FIG. 12, Activity Table.

Venue Server also communicates via Local Area Network Adapter 402 to LAN 208 in FIG. 2 and other components of the system.

FIG. 5 is a diagram of User Interface as seen in FIG. 2, User Interface 204 has a User Interface Microcomputer 505 that is attached via a LAN 508 and/or Serial Interface 507 to Venue Controller 205 and Venue Server 210 (optionally), and is attached to Venue Server 210 via LAN 508. User Interface Microcomputer 505 contains a Clock 506 that provides time in a form that includes the Month, Day-of-week, Hour, Minute, And Seconds. User Interface has a Display Screen 504, which can display textual and (optionally) graphical information to the user. Magnetic Stripe Reader 509 is provided to allow the input of user identification information from a variety of identification cards. Input Device 510 (like a keypad or touch screen) is used to allow the user to manually input information. Input Device 510 is typically a keypad or a touch screen. As User Interface Microcomputer 505 is programmable, it is capable of performing the various functions described elsewhere. The elements of FIG. 5, User Interface, are connected by a Local Bus 503. As implementations vary from manufacturer to manufacturer, more than one Local Bus 503 may be used. Processor Memory 500 contains Application 501 and Application Data 502 need to run the User Interface.

FIG. 6 is a diagram of a structure that represents a User Dialog. It is composed of a number of frame presentations. The presentations start with a User Dialog Block 600 called Initial Frame, which is a colletion of graphics and text, or audio information, to be presented to a user. Initial Frame ID 601 is a Frame ID for the first frame displayed for the activity. Associated with the Initial Frame ID 601 are a list of Frame ID 1 603, Frame ID 2 605 through Frame ID n 607 that are individually associated with a Selection ID 1 602, Selection ID 2 604, through Selection ID n 606. The selections are activated by the user pressing a touch element or key on a keypad associated with the various Selection IDs. Each of the User Dialog Block 600 is a table with a list of the allowable Selection Ids (such as Selection ID 1 602, Selection ID 2 604, through Selection ID n 606) and which correspond to Frame IDs (such as Frame ID 1 603, Frame ID 2 605 through Frame ID n 607), of the frame that is to be presented if that selection is made. User Dialog Block 600 are chained together using the various Frame IDs. As the Frame ID is used for the linkage, any meshed structure of User Dialog Block 600 is possible.

Frame ID 805 and Selection ID 806 in FIG. 8, User Selection Instrumentation Messages, are recorded as the user navigates through the User Dialog Block 600.

FIG. 7 is a data structure that describes the Frame Instrumentation Messages. The FIG. 7. Frame Instrumentation Message is generated by User Interface 204 when it presents a frame, and is sent to Venue Server 210 for forwarding to Central Server 200 where it is placed in Instrumentation Table 310. Record Type Flag 700 is a constant indicating “Frame” and is generated by Application 501 in FIG. 5, Point-of-sale Terminal. User ID 701 is extracted from the FIG. 13. User Table, as are: Venue ID 702, Point-of-sale Terminal ID 703, and Session Number 704. Frame ID 705 is extracted from the current FIG. 13 Selection Table entry. Time Stamp 706 is generated from the User Interface Microcomputer's 505 internal Clock 506.

FIG. 8 is a data structure that describes User Selection Instrumentation Messages. FIG. 8. User Selection Instrumentation Messages is generated by User Interface 204, when it detects a touch or key press. It is sent to Venue Server 210, for forwarding to Central Server 200, where it is placed in a table with the same format. Record Type Flag 800 is a constant and is generated by Application 501 in FIG. 5, User Interface, and idicates “Selection”. User ID 801 is extracted from the FIG. 13, User Session Table, as are: Venue ID 802, Point-of-sale Terminal ID 803, and Session Number 804. Frame ID 805 and Selection ID 806 are extracted from the current FIG. 13, Selection Table, Frame ID 1301 and Selection ID 1303. Time Stamp 807 is generated from the internal Clock 506 of User Interface Microcomputer 505.

FIG. 9 is an Instrumentation Table that describes a collection of FIG. 7, Frame Instrumentation Messages and FIG. 8, User Selection Instrumentation Messages. Record Type Flag 900 distinguishes between these. The FIG. 9, Instrumentation Table, is generated by FIG. 4, Venue Server, when it receives FIG. 7, Frame Instrumentation Messages, and FIG. 8, User Selection Instrumentation Messages, from Point-of-sale Terminal 206. Time Stamp 906, is copied from Time Stamp 807 from the corresponding FIG. 8, User Selection Instrumentation Messages, or FIG. 7, Frame Instrumentation Messages, by use of a conventional conversion routine. Depending on the instrumentation message associated with the entry for Record Type Flag 700 or Record Type Flag 800, from FIG. 7 and FIG. 8, User ID 901 is copied from either User ID 701 or User ID 801. In a similar manner, Venue ID 902, Point-of-sale Terminal ID 903, Session Number 904 and Frame ID 905 are copied from either FIG. 7, Frame Instrumentation Messages, User ID 701, Venue ID 702, Point-of-sale Terminal ID 703, Session Number 704 and Frame ID 705 or from FIG. 8, User Selection Instrumentation Messages, User ID 801, Venue ID 802, Point-of-sale Terminal ID 803, Session Number 804 and Frame ID 805.

The Instrumentation Table is sorted, summarized and accessed in FIG. 18, Dialog Generator, by different combinations of the fields; Venue ID 902, Point-of-sale Terminal ID 903, Time Stamp 906 and Session Number 904 to calculate for production of more efficent dialogs.

FIG. 10 is a data table that describes a the User Profile Table. This profile contains the information about the user's time consumption habits in various circumstances. User ID 1000 identifies a unique user. Venue ID 1001 identifies the venue the User Profile Table, applies to. Repeat for each Month, Day, and Day-part 1002 is indicates the following fields: First Most Likely Activity ID 1003, Second Most Likely Activity ID 1004, and Third Most Likely Activity ID 1005 are repeated for morning, mid-day, and evening for each day of the week and each month. The FIG. 10, User Profile Tables, are generated and stored at Central Server 200 (see FIG. 2), which down loads them to the venue specifed in Venue ID 1001.

FIG. 11 is the Venue Definition Table. The table contains a Venue ID 1100 which uniquely identifies the venue; Venue Type 1101 which is used, optionally, to build a FIG. 10, User Profile Table, that span instances of the same Venue Type 1101 or to build Venue Profile Tables that span instances of the same Venue Type 1101. Venue Definition Table, is built by Central Server 200 as stores are entered into the system.

FIG. 12 is the Activity Table, that has all the activities offered in the venue. An Activity is a single frame or a group of frames that create dialogs by stringing together frames based on user response. The activity is identified by the Activity ID 1200. User ID 1201 specifies the targeted user for that activity. The targeted user may be any identifed user having a unique identification code or an anonymous user, sharing one of the identificaiton codes set aside for anonymous users. Frame ID 1202 is the frame ID of the first frame displayed in an activity's FIG. 6, User Dialog. Frame ID 1202 is used to find an entry in FIG. 13 Selection Table with the same value in Frame ID 1301. This is graphically demonstrated in FIG. 6 User Dialog, where Selection ID 1 602 is linked by Frame ID 1 603 to the next User Dialog Block 600. The FIG. 6, User Dialog, Initial Frame ID 601 is assigned from Frame ID 1202. Form 1203 indicates whether the activity represented by this entry is a “normal” or a “combined” form of the activity. In this embodyment, the normal form is encoded as “0” and the combined forms are encoded as positive integer starting with one. The codes for the combined form are assigned sequenatially based on the probability that the form was selected. This allows multiple combined forms. If the user does not select the form presented, the system has the option of presenting another form to that user. Percent Taken 1204 is used when Form 1203 is not “normal”. It is used to assign Form 1203 in the order of the highest to lowest probability of the activity outcome being selected.

Each activity will have one entry in FIG. 12, Activity Table for each combination of Form 1203 and User ID 1201.

FIG. 13 is a representation of a Selection Table that is used with FIG. 12, Activity Table as an embodyment of FIG. 6, User Dialog. Activity ID 1300 points to the entry in FIG. 12, Activity Table, representing the activity associated with this entry in FIG. 13, Selection Table. Frame ID 1301 Identifies the frame that was active when the selection corresponding to Selection 1302 is activated. Selection 1302 identifies the key pressed or the touch area pressed by the user when the frame specified in Frame ID 1301 of the same entry is being presented to the user. Alternatitively it would specify the phrase or phrases if a voice entry unit were used in place of keypads or touch screens. Selection ID 1303 is a Frame ID 1301 that identifies the frame to be displayed because of the selection. Action Code 1304 specifies whether the system should: navigate to the next frame, or complete the selected outcome of the activity. Path Position 1305 is a code assigned to each frame that indicates the path through the dialog tree taken to get to the frame. The arrangement of the-entries in FIG. 13, Selection Table, via the Frame ID 1301, Selection ID 1303 pairs, permits the construction of tree structured dialogs, as shown in FIG. 6, User Dialog.

Each activity will have one or more entries in FIG. 13, Selection Table for each form of the activity. The entries are shown as unique to the form of an activity, but need not be.

FIG. 14 is a representation of an Activity Summary Table that is composed of an Activity ID 1400 and a Count 1401. Count 1401 is used in FIG. 18, Dialog Generator to keep track of the number of times an activity has been presented to an identifed user or to anonymous users.

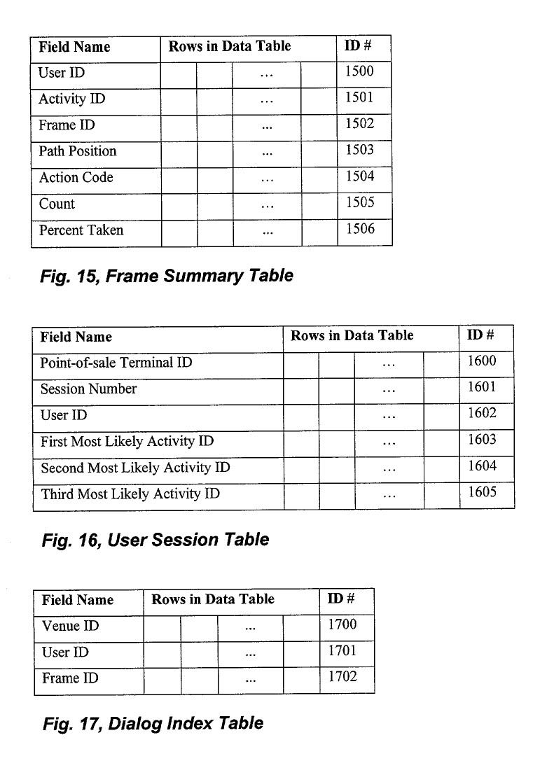

FIG. 15 is a representation of a Frame Summary Table that is composed of User ID 1500, Activity ID 1501, Frame ID 1502, Path Position 1503, Action Code 1504, Count 1505, and Percent Taken 1506. When processing the FIG. 9, Instrumentaion Table and the value in Frame ID 905 is encountered the first time, the contents of FIG. 13, Activity Table, is copied into the corresponding fields of this table, and the Count 1505 is set to 1. If the entry is already present, the Count 1505 is incremented. The Activity ID 1501 is found by looking up Frame ID 905 in FIG. 12, Activity Table and copying Activity ID 1200 to Activity ID 1501. If the frame being processed is the first or “Root” frame for an activity the Path Position 1503 is set to zero. Percent Taken 1506 is calculated as shown in FIG. 18, Dialog Generator.

FIG. 16 is the User Session Table at the point the user is first identified. Point-of-sale Terminal ID 1600 is set when the user is identified at a FIG. 5, User Interface. It is used to set Point-of-sale Terminal ID 803 and Point-of-sale Terminal ID 903 as instrumentation messages (FIG. 7 and FIG. 8) are built. Session Number 1601 is set by incrementing the last issued Session Number 1601 in the venue. User ID 1602 is provided by the user, generally by passing an identification card Magnetic Stripe Reader 209, from FIG. 5 If the user is anonymous (no ID) then one of the venus's anonymous User IDs is used. User ID 1602 is used to match to User ID 1000 to find the entry for the current customer in FIG. 10, User Profile Table. From FIG. 10: First Most Likely Activity ID 1003, Second Most Likely Activity ID 1004, and Third Most Likely Activity ID 1005, are entered into First Most Likely Activity ID 1603, Second Most Likely Activity ID 1604, and Third Most Likely Activity ID 1605 fields of the FIG. 16, User Session Table.

FIG. 17 is a representation of a Dialog Index Table. It contains the Venue ID 1700, identifiying the venue the specific FIG. 6, User Dialog, that is associated with the Frame ID 1702, and associated User ID 1701. In the case of a customer with a identification number the User ID 1701 will be the identification number. For anonymous users, the User ID 1701 will be one of the numbers assigned to anonymous users. It is produced in the FIG. 18, Dialog Generator to allow the distribution of the dialogs to the various venues.

FIG. 18 is a flow chart describing Dialog Generator that produces shortened FIG. 6, User Dialogs. Step 1800 sorts the FIG. 9, Instrumentation Table, by Time Stamp 906 within User ID 901. It then builds and intializes the FIG. 15, Frame Summary Table, sets up a loop to process the first set of entries for User ID 901 in FIG. 9, Instrumentation Table, and then passes control to Step 1801.

Step 1801 sets up a loop to process each entry in FIG. 9, Instrumentation Table, related to a single User ID 901; sets up FIG. 14, Activity Summary Table, and FIG. 15, Frame Summary Table as empty tables, and passes control to Step 1802.

Step 1802 extracts Frame ID 905 and locates FIG. 13, Selection Table for the entry having the same value in Frame ID 1301. Then Activity ID 1300 is used to locate the corresponding entry in FIG. 14, Activity Summary Table. Then Path Position 1305 is tested to see if it is a “Root” and if so and the Activity ID 1200 associated with Frame ID 905 is not in FIG. 14, Activity Summary Table a entry is created with Count 1401 set to one, otherwise Count 1401 is incremented by one. Then Action Code 1304 from the same entry is tested entry to determine if it a “navigate”. If so the control is passed to Step 1803, igoring the entry. Otherwise, the entry is processed by finding if the FIG. 15, Frame Summary Table has an entry with the same Activity ID 1300, User ID 901, and Frame ID 1301. If so, Count 1505 is incremented Otherwise an entry is created by setting User ID 1500 to User ID 901, Activity ID 1501 to Activity ID 1200, Frame ID 1502 to Frame ID 905, Path Position 1503 to Path Position 1305, Action Code 1504 to Action Code 1304, Count 1505 to one, and Percent Taken 1506 to 1 divided by Count 1401. It then sets up to access the next entry in the FIG. 9, Instrumentation Table and passes control to Step 1802.

Step 1803 determines if there are more entries in FIG. 9, Instrumentation Table, if so control is passed to Step 1802, otherwise control passes to Step 1804.

Step 1804 sorts the FIG. 15, Frame Summary Table sequence by Count 1505 within Activity ID 1501. It then counts the number of entries in the FIG. 15, Frame Summary Table saving it in the local variable Entry_Count. Then it sets up a loop to process the first Activity ID 1501 entries, and passes control to Step 1805.

Step 1805 test to Percent Taken 1506 to see if it is greater than Count 1505 divided by Entry_Count. This test can be modifed to allow greater selectivity by a number of means. For example, a criteria of x % better than random could be specified. In that case the test would be: Is Percent Taken 1506 greater than (1−(Count 1505 divided by Entry_Count))*x+Count 1505 divided by Entry_Count). If the test is met control is passed to Step 1807, otherwise to Step 1806.

Step 1806 access the next entry in FIG. 15, Frame Summary Table, if that was successful then Step 1808 passes control to Step 1805 to process that entry, otherwise control is passed to Step 1809. Step 1809 accsses the first entry for the next User ID 1500 and passes control to Step 1810. Step 1810 checks to see if Step 1809 was successful, and if so passes control to Step 1801 to process the next User ID 901. Otherwise the routine is ended.

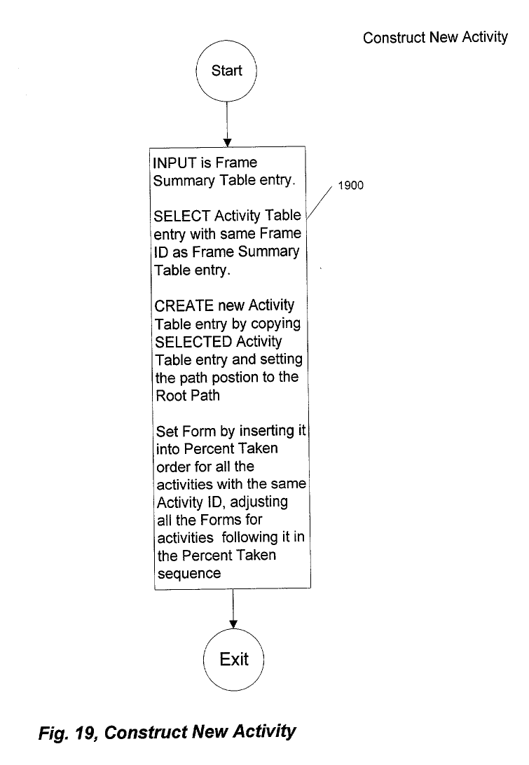

Step 1807 calls FIG. 19, Construct New Activity and upon return passes control to Step 1804.

FIG. 19 is a representation of a flow diagram to Construct New Activity. It is compose of Step 1900, which has as its NPUT is Frame Summary Table entry. It selects the entry in FIG. 12, Activity Table, with the same Frame ID 1202 as FIG. 15, Frame Summary Table, entry's Frame ID 1502. It then creates a new FIG. 12, Activity Table entry by copying the selected entry's Activity ID 1200, User ID 1201, and Frame ID 1202 into the new entry. Form 1203, of the new entry, is set by inserting it into Percent Taken order for all the activities with the same Activity ID 1200, and adjusting all the Forms for activities following it in the Percent Taken sequence.

Typical Hardware and Software Infrastructure

This invention is based on conventional Point-of-sale systems. Many manufacturers supply Point-of-sale equipment, and the invention is not limited to any particular manufacture's equipment. The invention can be implemented using IBM's 3680 Programmable Store System. The Store Controller 24 being an IBM 3650 and the Point-of-sale Terminal 50 being IBM 3683s.

IBM supplies software (IBM programmable store system MICRCODE) used in controlling operations in the hardware described and a program product (Subsystem Program Preparation Support II (SPPS II)) for writing controller and terminal programs. SPPS II includes languages, macro instructions, and a terminal display language. Communication between the terminals and the store controller is done by using a LAN and a program written in IBM 3650 Programmable Store System Microcode. Other application programs that form the infrastructure for the invention are SDM (Store Data Management) and HCP (Host Communication Program), both sold by IBM.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A system for presenting one or more activities to a user in a more efficient manner based on the history of prior use, the system comprising:
a) one or more terminals at one or more user locations, each having means for presenting information to said user and recording responses from said user;
b) a server with which said terminals can communicate, said server having a user database and an activity database;
c) said user database having a user identification means, a user profile means, and a user history means;
d) said activity database having means to identify and define the sequence of actions associated with said activities;
e) means for associating said user with one or more said activities;
f) means to track said user's paths through said sequence of actions.
g) means for reducing the number of said user's actions required to select said activities.

2. A system as in claim 1, where further means are provided to estimate the likely value of an activity, and to use said estimated value to further optimize said means for reducing the number of said user's actions.

3. A system as in claim 1, where further means are provided to evaluate differing said sequences of actions, each requireing the same or different number of said actions, with the objective of selecting the sequence that is most likely to be completed.

4. A system as in claim 1, where further means are provided to evaluate differing said sequences of actions, each requireing the same or different number of said actions, with the objective of selecting the sequence that is most likely to be more expediciously completed.

5. A system as in claim 1, where further means are provided to use said users said venue history and said venue profile from one or more first said venues and apply it in one or more second said venues.

6. A system as in claim 1, where further means are provided for a venue profile means, and a venue history means, which are used for unidentified users.

7. A system as in claim 7, where further means are provided to use said venue history and said venue profile from one or more first said venues and apply it in one or more second said venues.
